(19) United States
(12) Patent Application Publication
(10) Pub. No.: US 2024/0338754 A1
(43) Pub. Date: Oct. 10, 2024

(54) METHOD AND APPARATUS FOR BEAUTY PRODUCT DISTRIBUTION AND USE

(71) Applicant: Neen Inc., New York, NY (US)

(72) Inventor: Jeanine Lobell, New York, NY (US)

(21) Appl. No.: 18/746,972

(22) Filed: Jun. 18, 2024

Related U.S. Application Data
(63) Continuation of application No. 17/548,299, filed on Dec. 10, 2021.
(60) Provisional application No. 63/123,834, filed on Dec. 10, 2020.

(51) Int. Cl. G06Q 30/0601; G06F 9/451

(52) U.S. Cl. CPC G06Q 30/0643; G06F 9/453

(57) ABSTRACT

The system provides easy to use live beauty products and coordinated tutorials that can be viewed online, providing virtual expert assistance to users. In one embodiment, the system provides a card with integrated makeup products that can be exposed by the recipient of the card. In one embodiment, the card includes a face or faces, and the makeup products are hidden by a flap or cover alongside the faces, on which the products has been used. A QR code or other indicia is included on the card and automatically links to a tutorial for that particular card and makeup configurations. The tutorial instructs the user how best to apply and use the products. In one embodiment, the system implements a subscription service and cards are sent to a user on a periodic basis.

### RELATED APPLICATION(S)

This application is a continuation of U.S. application Ser. No. 17/548,299, filed on 10 Dec. 2021, which claims priority to U.S. Provisional Application Ser. No. 63/123,834 filed on 10 Dec. 2020, their contents of which are herein incorporated by reference in their entirety.

### BACKGROUND OF THE SYSTEM

The purchase of beauty products, such as makeup, often requires the use of samples, test bottles, in-store application, and even professional advice. Because of lack of knowledge of how to apply makeup, unfamiliarity with products, and/or differences in skin type, eye and hair color, skin tone, and other factors, a user may find it difficult to know what products to use and how to use them. A user would ideally like information on ways to use the product, and be able to try it on themselves, before purchasing to see how it works and how it looks on them. Even then, there are complexities associated with makeup purchase. In some cases, multiple products should be used together, each having its own color, texture, finish, and the like. It is sometimes difficult for a user to be certain that a number of products work well together for the user. Often a sales associate or makeup artist will assist a user in selecting appropriate and complementary products, and explain or show them how to use them, but such requires in-person contact and application.

A disadvantage of the present system is the time and effort, and often the presence of a trained sales associate, needed to identify, test, apply, remove, and re-apply, beauty products before finding the right combination. In addition, due to health and hygiene risks, from time to time, there are rules that limit human contact in retail establishments. Further, samples and test bottles are often left out for multiple users. The risks of contamination are too high, or are often perceived by customers to be too high. By the same token, the providing of single use samples for every customer for multiple products can be cost prohibitive.

In present times, the in-store experience is not really available. Even if it becomes available, users may decide that a more socially distant way of purchasing beauty products is desired. This problem is not limited to beauty products and cosmetics.

There are many products that are difficult to evaluate by a typical consumer. In present times the use of face masks presents a particular challenge to makeup purchasers.

The purchase of beauty products to create specific looks is also limited by knowledge of what products are required to create such looks, knowledge of how to create those looks, and the absence of any integrated product that provides all the products needed to create a makeup look.

### SUMMARY

The system provides easy to use live beauty products and coordinated tutorials that can be viewed online, providing virtual expert assistance to users. In one embodiment, the system provides a card with integrated makeup products that can be exposed by the recipient of the card. In one embodiment, the card includes a face on the front and faces on the back, made up using particular makeup products, and the makeup products are hidden by a flap or cover alongside the face on the front. QR codes or other indicia are included on the card and link to tutorials for the particular makeup configurations of each face. The tutorials instruct the user how best to apply and use the products. In one embodiment, the system implements a subscription service and cards are sent to a user on a periodic basis.

### BRIEF DESCRIPTION OF THE DRAWINGS

FIGS. 1A, 1B, and 1C are examples of cards that can be used m an embodiment of the system.

FIG. 2 is an example of a tutorial in an embodiment of the system.

FIG. 3 illustrates a network embodiment of the system.

FIG. 4 is a flow diagram illustrating the operation of the system in an embodiment.

FIG. 5 is an example computer system for implementing an embodiment of the system.

### DETAILED DESCRIPTION OF THE SYSTEM

Ideally users would like to be able to purchase the component products of certain makeup looks while receiving easily-accessible instruction, which they can access at their convenience, on how to use such products to achieve such looks. The system provides two or more products that can be used together to achieve a particular look or effect. The system also provides visual cues as to typical use of the products and provides easily accessed tutorials that explain proper use of the samples. In one embodiment the products comprise cosmetics, such as makeup for different parts of a face. The samples may be packaged in a variety of ways and include links to online tutorials for optimized use of the samples.

In one embodiment, the system provides the cosmetics on a card with makeup products embedded therein. There are a plurality of panels on each card, each with two or more makeup products shown in the image, graphic, or other indicia therein.

In one embodiment, each panel represents different skin types and skin tones, making it easy for users to select the correct panel that most closely matches their own type. In one embodiment, each card has a plurality of product combinations that may be optimized for that skin type. In one embodiment each panel represents different makeup looks, and users can select the look that they are most interested in applying.

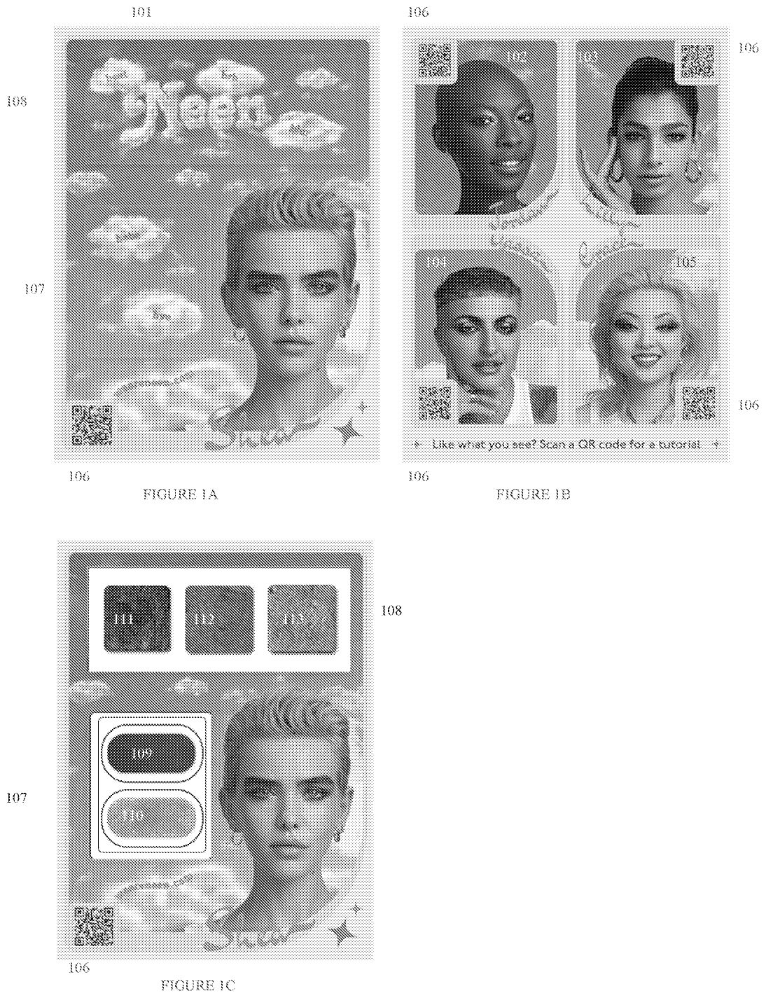

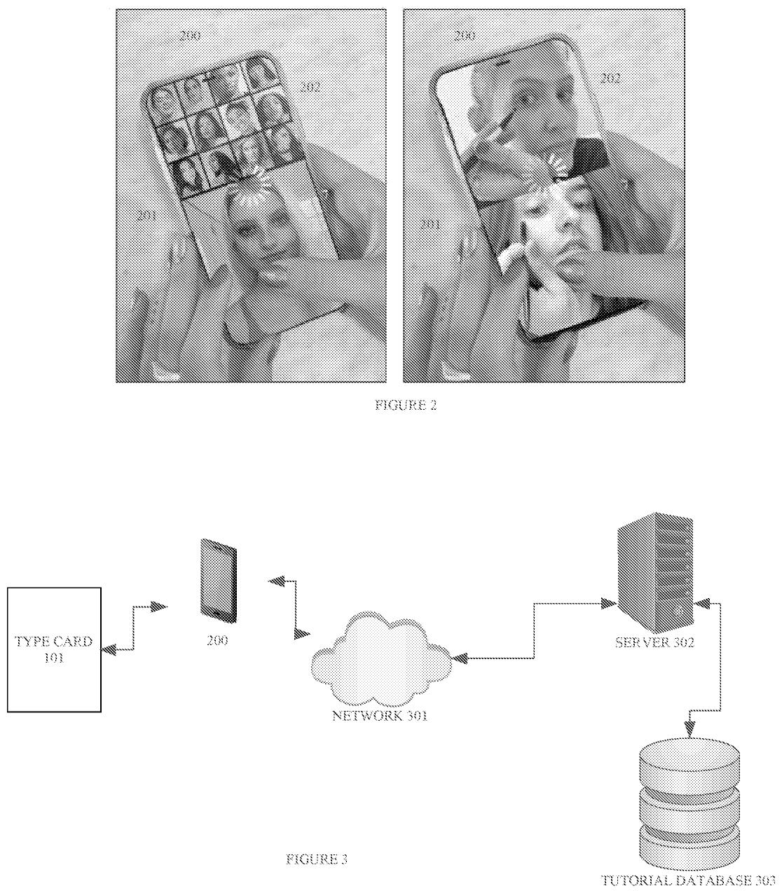

FIGS. 1A, 1B, and 1C illustrate a card for use in an embodiment of the system. FIG. 1A shows the front of a card with panel 101 and FIG. 1B illustrates the back of a card with different panels such as panels, 102, 103, 104, and 105, each showing an image of a face having different skin types. The image may be a photograph, graphic image, drawing, or the like. In one embodiment, the panel may just include an example of a skin type, face shape, and/or skin color. The system may include more and other panels than are shown here. There may be multiple versions of panels for each skin type, having different combinations of makeup.

In one embodiment, each card has makeup product embedded in the card. To make the card more intuitive to use, each makeup product can be labelled with the shade or product name, or may be located on or near where the product should be used on the face. (Note that the system may be implemented with the embedded makeup samples in any location as desired, even on the back of the card. Which products to use where and how may be explained in an associated tutorial). The makeup may be of any type, including creams and powders. In addition, the makeup may be for eyes, lips, cheeks, and the like.

In one embodiment, the embedded products are located behind a flap on a card that can be peeled back to reveal the products. FIG. 1C illustrates the card with the makeup on panel 101 exposed by removing the flaps. As shown in region 107 of FIG. 1C, there are lip/cheek makeup products 109 and a lip makeup product 110. These products are two different colors, but in one embodiment, they have been selected so that they are appropriate with any of the other makeup products on the card. In addition, each panel displays how the product can be appropriately used for the skin type of the model on the panel. Region 108 of FIG. 1C shows eye makeup products 111, 112, and 113.

In one embodiment, the card may contain two eyeshadows, a highlighter, a lip/cheek cream, and a lip gloss. The number and kinds of products may be adjusted without departing from the scope and spirit of the system. The cards are designed so that all the makeup products on a card may be used in any combination, and examples of such combinations are depicted on the panels. That is, the products are all complementary to each other. This avoids guesswork on the part of the user in selecting appropriate products. In one embodiment there may be products for cheeks, eyes, lips, and other parts of the face.

One advantage of the present system is that it combines powders and creams on a single card. Such a combination has not been available prior to this system.

Each card or each panel has an indicia I 06 that is used to access an associated tutorial. The indicia may be a QR code, bar code, URL, social media address, link, or other code used to direct the user to a tutorial associated with the card. The tutorial may be found on a network such as the internet. The user may be directed to a company website, a video streaming site (e.g. YouTube), a web page, and the like. The tutorial can be streamed and/or downloaded.

In one embodiment, the indicia can be scanned by a smartphone camera or the like, and the user is automatically directed to the tutorial. In one embodiment, the user may manually enter a link into a computing device and may then access the tutorial. In one embodiment, each panel may have a number on it. The user may be directed to a home page of a website and then asked to enter the number to then be directed to the associated tutorial.

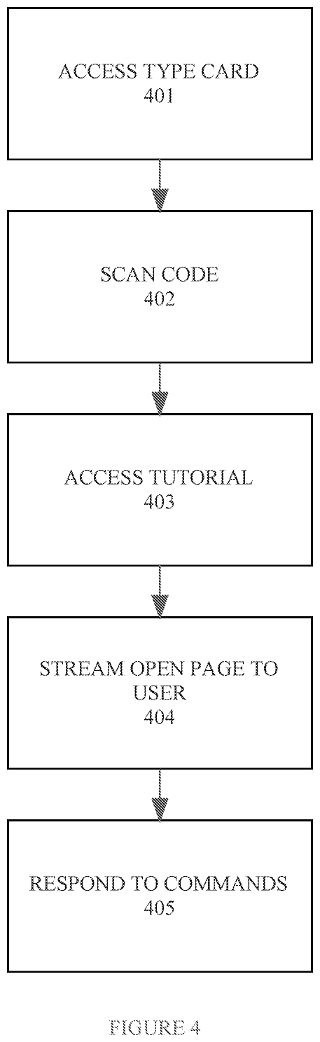

FIG. 2 is an example of images that are presented when the user links to the tutorial. On the left of FIG. 2, the system illustrates an example of what a user will see after using the link. The screen region 201 of a mobile device 200 shows an image of the card so the user knows that there is a match. Region 202 shows thumbnails of other cards or panels. If the presented card or panel does not match the card or panel of the user, the user may scan through the thumbnails to find the matching tutorial.

When in use, as on the right in FIG. 2, the system shows the model in region 202 applying the products. The camera of the mobile phone 200 is turned to selfie mode and the user can see themselves in region 201 applying the products, allowing for easy-to-follow application. In one embodiment, the video can also be expanded and watched without selfie mode. The system can provide video controls that appear when the user touches the screen, or uses voice commands, such as pause, rewind, fast forward, stop, restart.

Although the system has been described in connection with cards, the system may be utilized with other embodiments. The samples for a specific look could be physically delivered to a user with a corresponding direction in computer readable format to direct the recipient to an online tutorial to create the look and/or instruct on application. The samples could be boxed instead of integrated with a card and include the method of accessing the online tutorials.

In the card embodiment, the makeup products can be applied to a region of a card and then sealed with foil, plastic, cardboard, or the like. The seal can then be broken by the user to access the products. This helps to keep the products fresh and usable, particularly those that are soft or moist. In one embodiment, the cards may be manufactured via a printing process. In one embodiment, the cards may be manufactured via additive manufacturing (e.g. 3D printing).

FIG. 3 illustrates an example of the communication process for the system. The user scans the indicia 106 on the panel 101 using a smartphone 200. The smartphone transmits the code via internet cloud 301 to a systems server 302. The server 302 processes the code and retrieves the correct tutorial from the tutorial database 303 and transmits it back to the smartphone 200 through the network cloud 301.

The system may implement an app that can be used on mobile processing devices and/or desktop devices to operate the system. In other embodiments, the system may use the built-in linking capability of smartphones when scanning a QR code. The system may include a YouTube channel with additional content that will help the user and provide additional product options. The system provides samples, tutorials, learning, and additional products to surpass the in-person experience via a virtual environment.

FIG. 4 is a flow diagram illustrating the operation of the system in one embodiment. At step 401 a user accesses a card. At step 402 the user scans the code on the card that leads to the tutorial. This action sends the code to the system database and at step 403 the system accesses the selected tutorial and sends it to the user. In one embodiment the system displays the card associated with the code in one part of the user display and thumbnails of other tutorials in another section of the user display at step 404.

Although the system has been described in connection with cosmetics, it has equal application to other products as well. For example, the system may be used with scent strips, skincare products, and the like. These products may be implemented in combination with the makeup products or separately. In one embodiment, a card for skin care products (e.g. Face wash, toner, moisturizer, retinal cream, face oil, and the like) could be included on a card with a tutorial on how to use the products as part of a beauty routine. The card also has application for essential oils with associated tutorials. The system could also be used with health supplements for different body types, with tutorials on how to implement a wellness regime using the products.

In another embodiment the system may only display the associated panel to the user. If the displayed panel is a match, the user can simply initiate the playback. If there is no match, the user can tap a button on the display to bring up thumbnails of other panels to find the desired panel. At step 405 the system responds to user commands by playing back the tutorial, pausing, rewinding, forwarding, stopping, replaying, and the like.

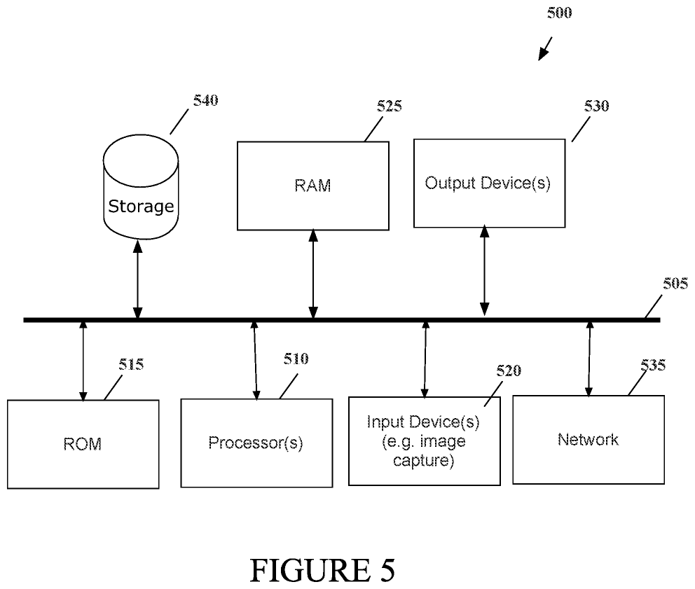

FIG. 5 illustrates an exemplary a system 500 that may implement the system. The electronic system 500 of some embodiments may be a mobile apparatus. The electronic system includes various types of machine readable media and interfaces. The electronic system includes a bus 505, processor(s) 510, read only memory (ROM) 515, input device(s) 520, random access memory (RAM) 525, output device(s) 530, a network component 535, and a permanent storage device 540.

The bus 505 communicatively connects the internal devices and/or components of the electronic system. For instance, the bus 505 communicatively connects the processor(s) 510 with the ROM 515, the RAM 525, and the permanent storage 540. The processor(s) 510 retrieve instructions from the memory units to execute processes of the invention.

The processor(s) 510 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine readable storage medium (also referred to as machine readable medium). When these instructions are executed by one or more of the processor(s) 510, they cause the processor(s) 510 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 510. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 500, define one or more specific machine implementations that execute and perform the operations of the software programs.

The ROM 515 stores static instructions needed by the processor(s) 510 and other components of the electronic system. The ROM may store the instructions necessary for the processor(s) 510 to execute the processes provided by the system. The permanent storage 540 is a non-volatile memory that stores instructions and data when the electronic system 500 is on or off The permanent storage 540 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 525 is a volatile read/write memory. The RAM 525 stores instructions needed by the processor(s) 510 at runtime, the RAM 525 may also store the real-time video or still images acquired by the system. The bus 505 also connects input and output devices 520 and 530. The input devices enable the user to communicate information and select commands to the electronic system. The input devices 520 may be a keypad, image capture apparatus, or a touch screen display capable of receiving touch interactions. The output device(s) 530 display images generated by the electronic system. The output devices may include printers or display devices such as monitors.

The bus 505 also couples the electronic system to a network 535. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18 (+) unless the element is expressly recited using the phrase “means for” or, in the case of a method claim, the element is recited using the phrase “step for.”

Thus a method and apparatus for distribution of beauty products has been described.

What is claimed is:

1. A method of providing a skincare product tutorial to a user comprising:
providing a card including;
a plurality of panels, each panel depicting a different skincare product application configuration;
a plurality of skincare product samples embedded in the card; and
a different indicia associated with each of the skincare product application configurations; and
processing, with a computer program product residing on a non-transitory computer readable medium having a plurality of instructions stored thereon which, when executed by a processor, cause the processor to perform operations comprising:
receiving an indication that a user has selected one of the skincare product application configurations by activating the indicia associated with the selected skincare product application configuration; and
serving a skincare product application tutorial associated with the selected skincare product application configuration to the user, wherein the skincare product application tutorial includes content instructing the user to recreate the skincare product application configuration using the plurality of skincare product samples.

2. The method of claim 1 wherein activating the indicia comprises scanning the indicia with a mobile communication device.

3. The method of claim 1 wherein activating the indicia comprises navigating to a website indicated by the indicia.

4. The method of claim 2 wherein the tutorial comprises video instructions for viewing on the mobile communication device.

5. The method of claim 4 further including enabling playback of the video instructions on one portion of a display of the mobile communication device and viewing of the user on another portion of the display of the mobile communication device.

6. The method of claim 1 wherein serving the skincare product application tutorial comprises streaming the tutorial to the user.

7. The method of claim 1 wherein serving the skincare product application tutorial comprises providing a download of the tutorial to the user.

8. The method of claim 1 wherein the indicia comprises one or more of a QR code, a bar code, a social media address, and a website link.

9. A method of providing a cosmetic product tutorial to a user comprising:
providing a card including;
a plurality of panels, each panel depicting a different cosmetic product application configuration;
a plurality of cosmetic product samples embedded in the card; and
a different indicia associated with each of the cosmetic product application configurations; and
processing, with a computer program product residing on a non-transitory computer readable medium having a plurality of instructions stored thereon which, when executed by a processor, cause the processor to perform operations comprising:
receiving an indication that a user has selected one of the cosmetic product application configurations by activating the indicia associated with the selected cosmetic product application configuration; and
serving a cosmetic product application tutorial associated with the selected cosmetic product application configuration to the user, wherein the cosmetic product application tutorial includes content instructing the user to recreate the cosmetic product application configuration using the plurality of cosmetic product samples.

10. The method of claim 9 wherein activating the indicia comprises scanning the indicia with a mobile communication device.

11. The method of claim 9 wherein activating the indicia comprises navigating to a website indicated by the indicia.

12. The method of claim 10 wherein the tutorial comprises video instructions for viewing on the mobile communication device.

13. The method of claim 12 further including enabling playback of the video instructions on one portion of a display of the mobile communication device and viewing of the user on another portion of the display of the mobile communication device.

14. The method of claim 9 wherein serving the cosmetic product application tutorial comprises streaming the tutorial to the user.

15. The method of claim 9 wherein serving the cosmetic product application tutorial comprises providing a download of the tutorial to the user.

16. The method of claim 9 wherein the indicia comprises one or more of a QR code, a bar code, a social media address, and a website link.

17. A method of providing a health and beauty product tutorial to a user comprising:
providing a card including;
a plurality of panels, each panel depicting a different health and beauty product application configuration;
a plurality of health and beauty product samples embedded in the card; and
a different indicia associated with each of the health and beauty product application configurations; and
processing, with a computer program product residing on a non-transitory computer readable medium having a plurality of instructions stored thereon which, when executed by a processor, cause the processor to perform operations comprising:
receiving an indication that a user has selected one of the health and beauty product application configurations by activating the indicia associated with the selected health and beauty product application configuration; and
serving a health and beauty product application tutorial associated with the selected health and beauty product application configuration to the user, wherein the health and beauty product application tutorial includes content instructing the user to recreate the health and beauty product application configuration using the plurality of health and beauty product samples.

18. The method of claim 17 wherein activating the indicia comprises scanning the indicia with a mobile communication device.

19. The method of claim 17 wherein the health and beauty product application tutorial includes content instructing the user to recreate the health and beauty product application configuration using at least one of the plurality of health and beauty product samples.

20. The method of claim 18 wherein the tutorial comprises video instructions for viewing on the mobile communication device.
